(19) United States
(12) Patent Application Publication
(10) Pub. No.: US 2010/0077560 A1
(43) Pub. Date: Apr. 1, 2010

(54) Golf Towel

(76) Inventor: Edwin L. Cabullo, Alpine, CA (US)

Correspondence Address: LAW OFFICE OF MARK WISNOSKY, 3200 Fourth Avenue, Suite 201, SAN DIEGO, CA, 92103, US

(21) Appl. No.: 12/243,682

(22) Filed: Oct. 1, 2008

(51) Int. Cl. A47L 25/00; B67D 5/06

(52) U.S. Cl. 15/209.1; 222/192

(57) ABSTRACT

A golf towel with a pocket and embedded in the pocket a reservoir for dispensing cleaning liquid is described. The towel design and reservoir system enables controlled release of the liquid only when required for cleaning. The system allows temporal control for release of the liquid, control of the amount of liquid released, and, control of the location on the towel to which the liquid is dispensed.

### TECHNICAL FIELD

The present invention relates to a golf towel that includes a bladder for water or other cleaning fluid and a means to controllably dispense the fluid and moisten the towel.

### RELATED BACKGROUND ART

Golf towels and gloves that are made to clean golf balls and clubs and wipe the golfers hands are known. Often the cleaning task requires scrubbing using the towel material and some fluid, typically water. However keeping a towel moist through the several hours required to finish a round of golf is a challenge. Previous solutions have included sponges or other such means to hold water or other solution. But most often this solution wither releases too much water creating discomfort if the towel is attached to the golfer or a mess if the towel is attached to the golf bag. After releasing too much water the towel often dries out and is no longer effective for cleaning before the round of golf is completed. Weather also is a factor in the effectiveness of a golf towel. On extremely hot or hot and dry days, a towel will dry out very quickly. Open reservoirs such as sponges for water or cleaning fluid will be drained before a round can be completed. On wet or rainy days the towel may be too wet just from the weather. An open reservoir will capture unwanted moisture.

There is a need for a simple golf towel and reservoir system that can hold sufficient water or other cleaning fluid as required for a complete round of golf. There is a need for a golf towel and reservoir that will controllably release moisture. There is a need for golf towel and reservoir that will avoid soaking up moisture during rain or other sources of external moisture.

### DISCLOSURE OF THE INVENTION

A golf towel that incorporates a pocket for a reservoir and a reservoir that can controllably release its fluid contents is described. A pocket is attached to the towel. In a preferred embodiment the pocket is made of the same material as the towel. In one embodiment the pocket is attached to the towel by sewing. In another embodiment the pocket is removably attached to the towel using for example a hook and loop closure mechanism. Typically the towel is made of a terry cloth or similar material that is absorbent and provides some abrasion for cleaning golf balls, clubs and golfers hands. In one embodiment the reservoir is made of a flexible material such as rubber, neoprene or silicone. The reservoir is removable and may be filled with water or other fluid and then replaced in the pocket of the towel. One embodiment of the towel includes a hook and loop closure mechanism to retain the reservoir in place. The reservoir controllably releases the contained fluid. In a preferred embodiment the reservoir is punctured with an array of pinholes that are sealed under normal atmospheric pressure and leak fluid when the reservoir is subjected to pressure such as through squeezing. In another embodiment the reservoir is fitted with a valve mechanism to release the contained fluid. In one embodiment the valve mechanism is made of a flexible material that opens the valve and releases fluid through squeezing of the valve material and opening a slot for fluid flow. In another embodiment the valve is made of flexible tube shaped material that when bent opens an internal valve mechanism and releases fluid. In one embodiment the number of pinholes in the reservoir is adjusted to produce an effective level of flow. In one embodiment the number of pinholes may be adjusted based upon the surface tension of the cleaning fluid; a lower surface tension fluid requiring fewer holes to produce an equivalent flow as is observed with a higher surface tension fluid.

### BRIEF DESCRIPTION OF THE DRAWINGS

FIG. 1 is a view of a golf towel with a pocket and removable fluid reservoir.

FIG. 2 shows a front view and a side view of a fluid reservoir useful in embodiments of the invention.

FIG. 3 shows front, side and close up view of the valve for a second reservoir embodiment of the invention.

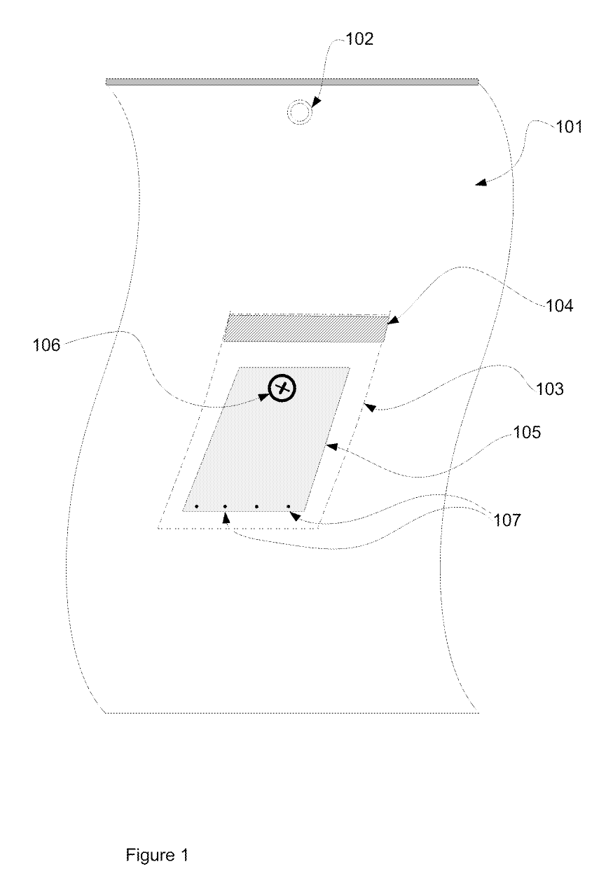

### DETAILED DESCRIPTION

Referring to Figure a golf towel 101 is shown with a grommet 102 to attach the towel to the golfer or the golfer's club bag. The towel includes a pocket 103 sewn into the towel. The pocket is sewn into the towel. The pocket is preferably made of the same material as the towel. In another embodiment the pocket may be attached to the towel by sewing or by other means such as a hook and loop attachment system sold as Velcro, a registered trademark of Velcro Industries B.V. limited Liability Company, Netherlands. The pocket further includes a closable flap 104 which may be securely closed using a hook and loop system, a button, zipper or other means known in the art. A reservoir 105 is placed within the pocket 103. The reservoir may be made of any material capable of holding a liquid. In a preferred embodiment the reservoir is made of an elastomeric material such as a thermoplastic elastomer, silicone or rubber. The material comprising the reservoir is between 0.01 and 0.1 inches thick. The reservoir further includes a sealable port 106 to allow addition and removal of liquid from the reservoir. In a preferred embodiment the port 106 includes a screw cap to close the port after filling. In one embodiment the reservoir further includes holes 107 that may allow fluid to flow from the reservoir and thereby dampening the towel material. In a preferred embodiment the holes 107 are pinholes of a size such that the liquid within the reservoir will not flow unless pressure is applied to the walls of the reservoir thus distending the reservoir, opening the holes and forcing fluid to flow. In one embodiment the holes include a plurality of holes the number chosen such that an amount of fluid flows for effectively dampening the towel material for the cleaning purposes flows upon squeezing the reservoir. The pinholes may be formed in the reservoir using a pin or other similarly pointed object. In a preferred embodiment the diameter of the pin is less than 0.05 inches and the thickness of the reservoir material is between 0.01 and 0.1 inches and the number of holes is more than 5 and less than 50.

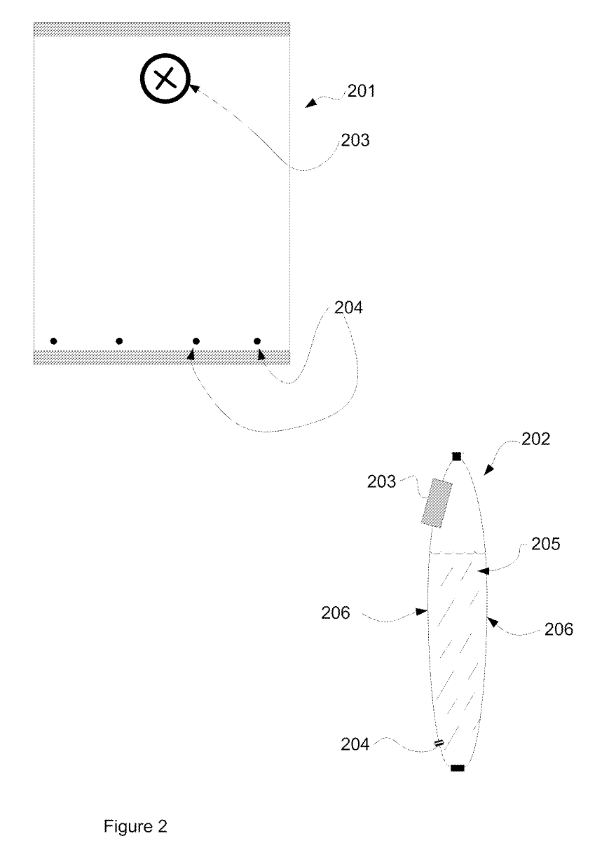

FIG. 2 depicts a front 201 and a side 202 view of the reservoir. The reservoir includes a port 203 for filling and emptying the reservoir of liquid as required. Liquid 205 is placed into the reservoir and the fill cap 203 is replaced. The fill cap should be liquid tight, not allowing liquid to leak from the reservoir even when pressure is placed upon the walls of the reservoir. In one embodiment the reservoir is made of elastomeric material. In this embodiment the walls of the reservoir 206 bow out slightly when the reservoir is filled with water. Pressing on the walls will increase the pressure on the interior of the reservoir. Pressing at the walls at the points indicated by the arrows 206 will cause the elastomeric reservoir to distend at the non compressed regions such as the bottom hole locations 204. This action causes the holes to stretch and open. The combination of increased interior pressure and the distending of the hole regions 204 cause liquid to flow from the reservoir outwardly through the holes 204. Releasing the pressure on the sidewalls causes the pressure within the reservoir to decrease and simultaneously the holes return to their original sealed configuration thereby stopping the flow. Although the holes 204 are shown along the bottom edge of the reservoir in FIG. 2, in practice the holes may be located anywhere on the reservoir surface. In another embodiment the number of holes over a region of the reservoir surface is used to control the relative amount of moisture dispensed to that region of the towel. More liquid will be dispensed in regions with a larger number of holes than in regions with a fewer number of holes. In another embodiment the holes are localized to a single side of the towel resulting in a wet side for cleaning and a dry side for drying.

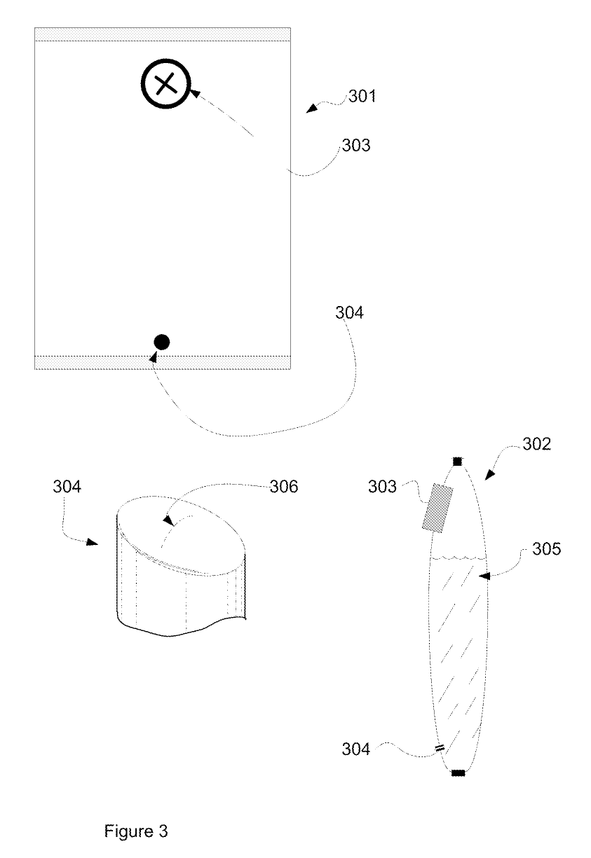

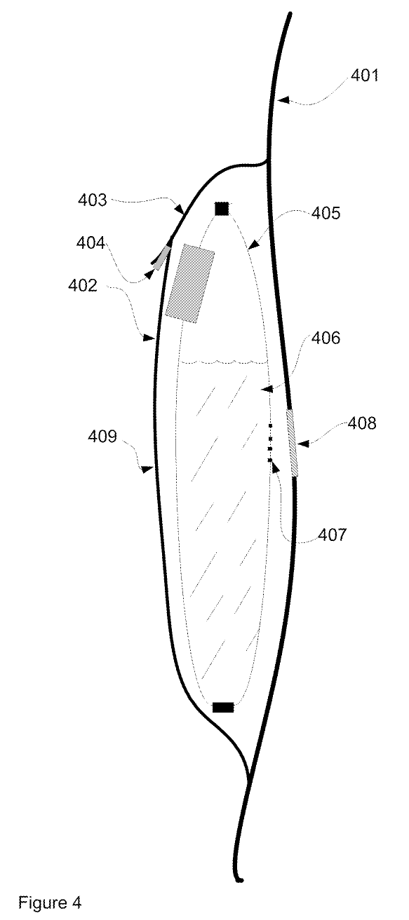

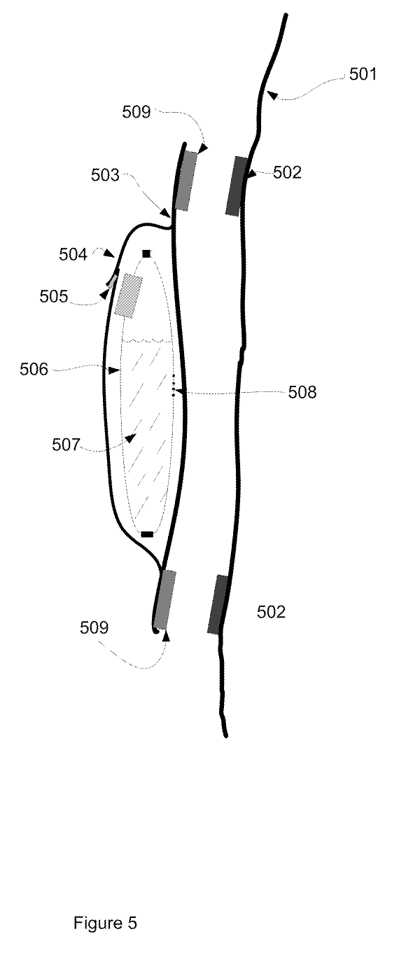

In other embodiments of the invention the holes are replaced with a valve or a plurality of valves. FIG. 3 depicts the reservoir portion of the invention for these other embodiments. The reservoir is shown in a front view 301 and a side view 302. The reservoir includes a port 303 for filling or removing liquid 305 from the reservoir. In one embodiment the reservoir includes a valve 304 for dispensing liquid from the reservoir. In one embodiment the valve is of the type show in FIG. 3. The valve is preferably made of elastomeric material and includes a slit 306 cut into the valve body. Squeezing the sides of the valve 308 causes the body to distort and opens the slit 306 thus allowing fluid flow. In another embodiment, not shown, the valve is cylindrical and made of an elastomeric material. Pushing on one side of the cylinder bends the cylinder and causes a valve mechanism within the cylinder to open and allow flow of liquid from the reservoir. Other valve configurations known in the art could also be used.

Another embodiment of the invention is shown in FIG. 4. To a towel 401 made of flat flexible material such as terry cloth is attached a pocket 402. The pocket includes a closable flap 403 and a closure means for the flap 404. The closure means may be snaps, buttons or other means. In a preferred embodiment the closure means is a hook and loop material. A reservoir 405 is encased within the pocket. The reservoir is filled with a liquid 406, typically water. The reservoir includes a plurality of pinholes 407. The pinholes are localized to a region such that when the back is squeezed as previously discussed, the liquid is controllably dispensed to a localized region 408 of the towel material. The liquid will be dispensed to the localized regions leaving the rest of the towel, such as the other side 409 of the embedded pocket dry. The embodiment thereby provides a means to localize wet the towel for cleaning a golf ball, club or the golfer's hands wile maintaining the remainder of the towel dry for drying the golf ball, club or the golfer's hands.

In another embodiment shown in FIG. 5 a detachable pocket 503 is attached to a golf towel 501 that is fitted with attachment means 502 that mate with attachment means 509 on the removable pocket. The pocket is made of material through which moisture will readily pass. In one embodiment the pocket is made of the same material as the towel. The features of the pocket and an enclosed reservoir 506 are as have been previously discussed in conjunction with pockets that may be sewn on or otherwise attached to the towel. The pocket includes a sealable flap 504 and means to close the flap 505. The reservoir 506 is filled with liquid 507 that will be dispensed through pinholes 508. The pinhole locations may be localized as shown to dispense the liquid to a selected region of the towel material. Both the location of the attachment means 502 and the location of the holes 508 may be selected to localize the dispensing of the liquid. In another embodiment, not shown, the pinholes may be replaced with other dispensing means such as a valve as discussed previously. The pocket embodiment enables the modification of any towel to create a cleaning system where liquid may be controllably dispensed onto a towel surface.

Conclusions

A golf towel with a pocket and embedded in the pocket a reservoir for dispensing cleaning liquid is described. The towel design and reservoir system enables controlled release of the liquid only when required for cleaning. The system allows temporal control for release of the liquid, control of the amount of liquid released, and, control of the location on the towel to which the liquid is dispensed.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

I claim:

1. A golf towel comprising:
a) a flat flexible fabric material having a front side and a back side,
b) a pocket attached to the front side,
c) a reservoir, capable of containing a liquid, having a front wall and a back wall contained in the pocket,
d) a means to add liquid to the reservoir, and,
e) a means to controllably release the liquid from the reservoir.

2. The golf towel of claim 1 where the reservoir is made of an elastomeric material.

3. The golf towel of claim 2 where the means to controllably release the liquid is a plurality of pinholes in at least one of the walls of the reservoir.

4. The golf towel of claim 3 where the pinholes are located on only one of the walls of the reservoir.

5. The golf towel of claim 1 where the means to controllably release the liquid is a valve.

6. The golf towel of claim 5 where the valve is located on only one wall of the reservoir.

7. The golf towel of claim 1 where the pocket further comprises a closeable flap.

8. The towel of claim 1 where the pocket is removably attached to the front side of the flat flexible material.

9. A liquid dispensing system for attachment to a golf towel comprising:
a) a pocket made of flexible material that will transmit liquid,
b) a reservoir capable of containing a liquid, said reservoir of a size to fit within the pocket, and having a front wall and a back hall,
c) a means to controllably release the liquid from the reservoir,
d) a sealable means to add liquid to the reservoir, and
e) a means to removably attach the pocket to a golf towel.

10. The dispensing system of claim 9 where the reservoir is made of an elastomeric material.

11. The dispensing system of claim 10 where the means to controllably release the liquid is a plurality of pinholes in at least one of the walls of the reservoir.

12. The dispensing system of claim 11 where the pinholes are located on only one of the walls of the reservoir.

13. The dispensing system of claim 10 where the means to controllably release the liquid is a valve.

14. The dispensing system of claim 13 where the valve is located on only one wall of the reservoir.

15. The dispensing system of claim 10 where the pocket further comprises a closeable flap.
